(19) United States
(12) Patent Application Publication
(10) Pub. No.: US 2026/0143277 A1
(43) Pub. Date: May 21, 2026

(54) SPEAKER AND ELECTRONIC DEVICE

(71) Applicant: AAC Kaitai Technologies (Wuhan) CO., LTD., Wuhan (CN)

(72) Inventors: Linxin Zhang, Wuhan (CN); Qiang Dan, Wuhan (CN); Yufen Chu, Wuhan (CN); Yao Hui, Wuhan (CN); Yang Li, Wuhan (CN)

(21) Appl. No.: 19/169,029

(22) Filed: Apr. 3, 2025

Related U.S. Application Data
(63) Continuation of application No. PCT/CN2024/132605, filed on Nov. 18, 2024.

(51) Int. Cl. H04R 1/28; H04R 7/06

(52) U.S. Cl. CPC H04R 1/2803; H04R 7/06; H04R 2201/003

(57) ABSTRACT

Provided is a speaker, including: a diaphragm structure including first and second diaphragms, the first diaphragm is configured to push air to vibrate to generate initial sound wave, and a signal of which is modulated based on a signal within an audible sound frequency band; and a cover plate structure enclosing with the diaphragm structure to form sound-generating cavity, the cover plate structure has a sound outlet hole connecting the sound-generating cavity with outside, the initial sound wave in the sound-generating cavity is transmitted to the outside through the at least one sound outlet hole to form a sound signal, the second diaphragm and the cover plate structure generate an acoustic environmental impedance used to modulate the initial sound wave to change sound pressure of the sound signal. The speaker can modulate and output a sound signal covering the audible sound frequency band based on the acoustic environmental impedance.

### TECHNICAL FIELD

The present disclosure relates to the field of acoustic-electrical conversion technologies, and in particular to a speaker and an electronic device.

### BACKGROUND

As an important electro-acoustic device, the micro-speaker is widely used in consumer electronic devices. Micro-speakers can be classified into moving-coil micro-speakers, moving-iron micro-speakers, and micro-electro-mechanical system (MEMS) speakers according to technical types.

At present, both the moving-coil micro-speakers and moving-iron micro-speakers drive a vibrating structure through electromagnetic force to generate sound, and may be interfered by an external magnetic field during operation, which adversely affects their performance. Moreover, it is difficult to further reduce their sizes. In contrast, MEMS speakers do not suffer from the above-mentioned problems and they have many advantages such as low power consumption, low cost, small size, and high consistency.

However, the performance of MEMS speakers in outputting the sound signal that cover the audible sound frequency band still needs to be improved.

### SUMMARY

In view of the above problems, the main purpose of the present disclosure is to provide a speaker that can modulate and output a sound signal covering the audible sound frequency band based on the acoustic environmental impedance.

To achieve the above objective, technical solutions of the present disclosure provide a speaker, including: a diaphragm structure, the diaphragm structure includes a first diaphragm and a second diaphragm, the first diaphragm is configured to push air to vibrate so as to generate an initial sound wave, and a signal of the initial sound wave is modulated based on a signal within an audible sound frequency band; and a cover plate structure, the cover plate structure and the diaphragm structure enclose to form a sound-generating cavity, the cover plate structure has at least one sound outlet hole, the at least one sound outlet hole connects the sound-generating cavity with outside, the initial sound wave in the sound-generating cavity is transmitted through the at least one sound outlet hole to the outside so as to form a sound signal, the second diaphragm and the cover plate structure form an acoustic environmental impedance, and the acoustic environmental impedance is used to modulate the initial sound wave to change sound pressure of the sound signal.

As an improvement, a frequency of the initial sound wave is a preset frequency, and the second diaphragm is used to vibrate at the preset frequency.

As an improvement, the first diaphragm is arranged around the second diaphragm.

As an improvement, the second diaphragm is arranged around the first diaphragm.

As an improvement, the at least one sound outlet hole is arranged directly opposite to the first diaphragm, and the cover plate structure at least blocks the second diaphragm.

In one or more embodiments, an intermediate layer is provided within the sound-generating cavity, the intermediate layer is located between the diaphragm structure and the cover plate structure, the intermediate layer has at least one through-hole that penetrates through the intermediate layer, the at least one through-hole is arranged directly opposite to the first diaphragm, and the at least one through-hole and the at least one sound outlet hole are arranged in a staggered manner. The intermediate layer at least blocks the second diaphragm to form the acoustic environmental impedance together with the second diaphragm and the cover plate structure.

As an improvement, a driving mode of the first diaphragm includes electrostatic driving, piezoelectric driving, or electromagnetic driving, and a driving mode of the second diaphragm includes electrostatic driving, piezoelectric driving, or electromagnetic driving.

As an improvement, a shape of the first diaphragm includes circular, square, hexagonal, or annular, and a shape of the second diaphragm includes circular, square, hexagonal, or annular.

As an improvement, the speaker further includes: a shielding element located on a side of the cover plate structure away from the sound-generating cavity, and the shielding element at least blocks part of the at least of sound outlet hole.

Technical solutions of the present disclosure further provide an electronic device, which includes the speaker as described in the above embodiments.

The beneficial effects of the present disclosure are as follows: the diaphragm structure and the cover plate structure enclose to form a sound-generating cavity, the diaphragm structure includes a first diaphragm and a second diaphragm, the first diaphragm is configured to push air to vibrate so as to generate an initial sound wave, the second diaphragm and the cover plate structure form an acoustic environmental impedance, which is used to modulate the initial sound wave, so that the sound signal transmitted through the sound outlet hole of the cover plate structure is a sound signal within the audible sound frequency band.

### BRIEF DESCRIPTION OF DRAWINGS

In order to explain the technical solutions in the embodiments of the present disclosure more clearly, a brief introduction will be made to the drawings used in the description of the embodiments. It is understandable that, the drawings in the following description are only some embodiments of the present disclosure. For those of ordinary skill in the art, without creative efforts, other drawings can also be obtained based on these drawings.

FIG. 1 is a schematic diagram of an equivalent circuit modeling structure of a speaker according to one or more embodiments of the present disclosure.

FIG. 2A is a spectrogram corresponding to a sound pressure signal of a sound source according to one or more embodiments of the present disclosure.

FIG. 2B is a spectrogram corresponding to an acoustic environmental impedance according to one or more embodiments of the present disclosure.

FIG. 2C is a spectrogram corresponding to a sound pressure signal of an output sound signal according to one or more embodiments of the present disclosure.

FIG. 3 is a schematic structural diagram of a first type of speaker according to one or more embodiments of the present disclosure.

FIG. 4 is a schematic structural diagram of a second type of speaker according to one or more embodiments of the present disclosure.

FIG. 5 is a schematic structural diagram of a third type of speaker according to one or more embodiments of the present disclosure.

FIG. 6 is a schematic structural diagram of a fourth type of speaker according to one or more embodiments of the present disclosure.

### DESCRIPTION OF EMBODIMENTS

To better illustrate the objectives, technical solutions, and advantages of the present disclosure, the various embodiments of the present disclosure will be elaborated in detail in conjunction with the drawings. However, those of ordinary skill in the art can understand that, in the various embodiments of the present disclosure, many technical details are provided to help readers to better understand the present disclosure. Nevertheless, even without these technical details and various changes and modifications based on the following embodiments, the technical solutions claimed by the present disclosure can still be achieved.

In the description of the embodiments of the present disclosure, technical terms such as “first” and “second” are only used to distinguish different objects and should not be construed as indicating or implying the relative importance, nor as implicitly specifying the quantity, specific order, or primary-secondary relationship of the indicated technical features. In the description of the embodiments of the present disclosure, the meaning of “multiple” is two or more, unless otherwise specifically defined.

When the term “embodiments” is mentioned herein, it means that the specific features, structures, or characteristics described in conjunction with the embodiments can be included in at least one embodiment of the present disclosure. The appearance of the term in various positions in the specification does not necessarily refer to the same embodiment, nor is it an independent or alternative embodiment mutually exclusive with other embodiments. Those of ordinary skill in the art explicitly and implicitly understand that the embodiments described herein can be combined with other embodiments.

In the description of the embodiments of the present disclosure, technical terms such as “center”, “longitudinal”, “lateral”, “length”, “width”, “thickness”, “over”, “under”, “front”, “rear”, “left”, “right”, “vertical”, “horizontal”, “top”, “bottom”, “inner”, “outer”, “clockwise”, “counterclockwise”, “axial”, “radial”, “circumferential”, etc. indicate the orientation or positional relationship based on the orientation or positional relationship shown in the drawings. This is only for the convenience of describing the embodiments of the present disclosure and simplifying the description, rather than indicating or implying that the indicated device or element must have a specific orientation, be constructed and operate in a specific orientation. Therefore, it should not be understood as any limitation on the embodiments of the present disclosure.

In the description of the embodiments of the present disclosure, unless otherwise clearly defined and limited, technical terms such as “installation”, “join”, “connection”, “fixation”, etc. should be understood in a broad sense. For example, it can be a fixed connection, a detachable connection, or integrated as an entirety, it can also be a mechanical connection or an electrical connection, it can be directly connected or indirectly connected through an intermediate medium, and it can be the internal communication of two elements or the interaction relationship between two elements. For those of ordinary skill in the art, the specific meanings of the above terms in the embodiments of the present disclosure can be understood according to specific situations.

In the drawings corresponding to the embodiments of the present disclosure, the thickness and area of layers are enlarged for better understanding and ease of description.

In the description of the embodiments of the present disclosure, when a certain component “includes” another component, unless otherwise specified, other components are not excluded, and other components may further be included.

The terms used in the description of various embodiments herein are only for describing specific embodiments and are not intended to be any limitation. As used in the description of various embodiments and the appended claims, “component” is also intended to include the plural form, unless the context clearly indicates otherwise.

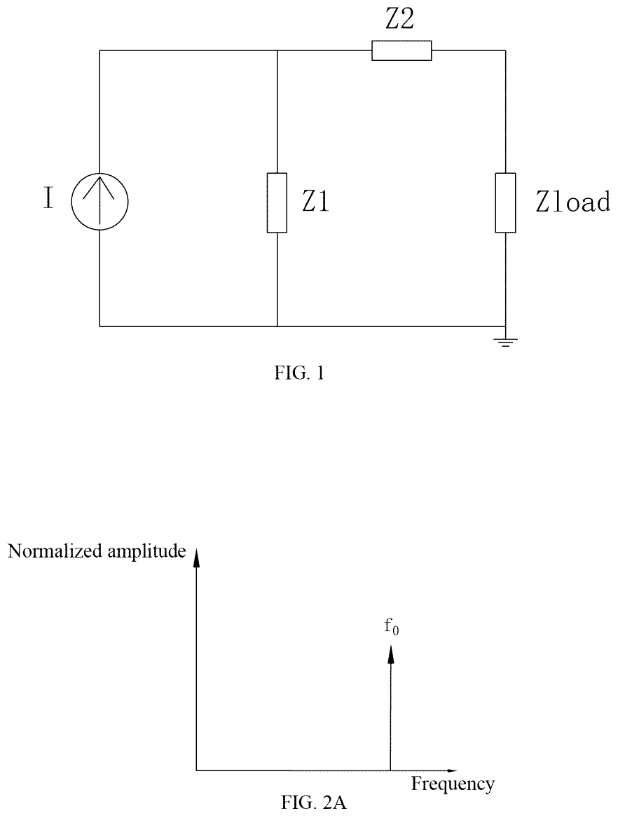

FIG. 1 is a schematic diagram of an equivalent circuit modeling structure of a speaker according to one or more embodiments of the present disclosure.

In a speaker, a diaphragm is usually used to push air to vibrate so as to generate a sound signal that spreads in all directions. During the propagation of the sound wave, the environment, propagation path, and load of the sound wave will cause losses of the sound wave, thereby affecting the sound pressure of the sound signal obtained by the load. Referring to FIG. 1, the sound source generated by the diaphragm is equivalent to a constant current source I. The losses of the sound wave of the sound source affected by the environment is equivalent to the acoustic environmental impedance Z1. For example, the losses of the sound wave affected by environmental structures such as walls, skin, and sound absorbers. The losses of the sound wave of the sound source due to obstacles in the propagation path is equivalent to the acoustic path impedance Z2. For example, the losses of the sound wave affected by the obstacles in front of the sound outlet hole. The losses of the sound wave of the sound source due to the influence of the load itself is equivalent to the load impedance Zload. For example, the losses of the load may be the losses caused by the human ear or the microphone itself. The acoustic environmental impedance Z1 is equivalent to being in parallel with the sum of the acoustic path impedance Z2 and the load impedance Zload, to serve as the total impedance of the constant current source I.

For example, taking the sound wave with an ultrasonic frequency of f0 generated by the diaphragm pushing air as the sound source, the constant current source I is expressed as the product of the diaphragm area and the amplitude velocity. The sound source is modulated by the audible sound frequency fₐ, fₐ may be any value between 20 Hz and 20 kHz. The constant current source I satisfies the following relational expression (1):

$$I = {I}_{0} sin ( 2 {πf}_{0} t ) sin ( 2 {πf}_{a} t ) .$$

Where I₀ is a constant, and t represents time.

The acoustic environmental impedance Z1 is modulated based on the ultrasonic frequency f₀ of the sound source. The acoustic environmental impedance Z1 satisfies the following relational expression (2):

$$Z 1 = Z 0 sin ( 2 {πf}_{0} t ) .$$

Where Z0 is a constant.

Combining the relational expression (1) and relational expression (2), the sound pressure Pload on the load can be obtained:

$$Pload = 1 \frac{Z 1}{Z 1 + Z 2 + Zload} Zload .$$

When the obstacles on the propagation path of the sound wave remains unchanged, the acoustic path impedance Z2 is a constant value. When the load is determined, the load impedance Zload is a constant value.

Therefore, when Z0<Z2+Zload, the sound pressure Pload transmitted to the load after being modulated by the acoustic environmental impedance Z1 can be obtained:

$$Pload \approx {I}_{0} \frac{Z 0 \times Zload}{Z 2 + Zload} sin ( 2 {πf}_{0} t ) \times sin ( 2 {πf}_{a} t ) \times sin ( 2 {πf}_{0} t ) .$$

Finally, the sound pressure Pa at the audible sound frequency fₐ:

$$P a = \frac{{I}_{0}}{2} \times \frac{Z 0 \times Zload}{Z 2 + Zload} \times sin ( 2 {πf}_{0} t ) .$$

Thus, the speaker can modulate and output the sound signal covering the audible sound frequency band based on the acoustic environmental impedance Z1.

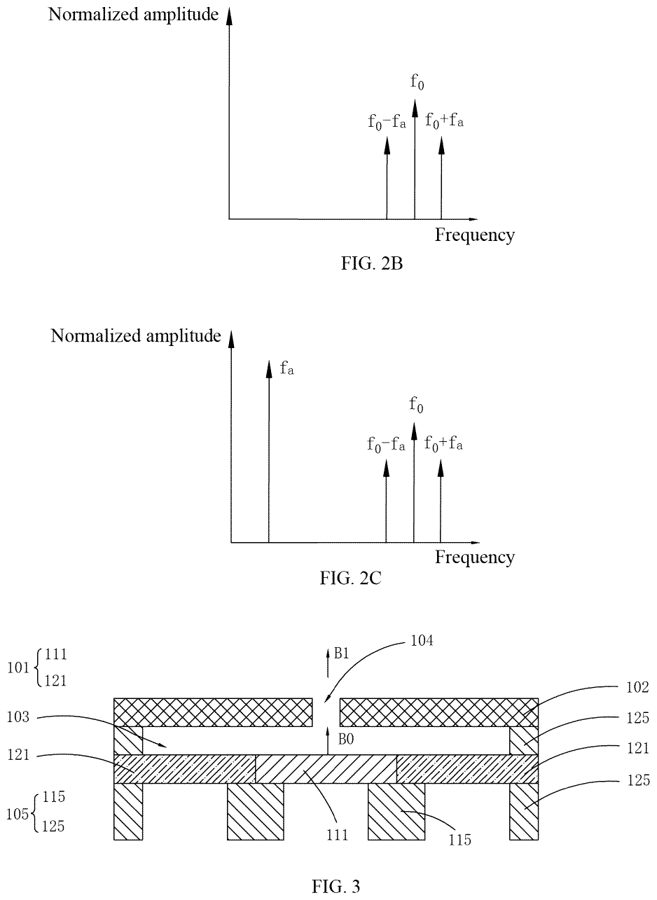

FIG. 2A is a spectrum diagram corresponding to a sound pressure signal of a sound source according to one or more embodiments of the present disclosure. FIG. 2B is a spectrum diagram corresponding to an acoustic environmental impedance according to one or more embodiments of the present disclosure. FIG. 2C is a spectrum diagram corresponding to a sound pressure signal of an output sound signal according to one or more embodiments of the present disclosure.

Referring to FIG. 2A, after modulating the sound pressure signal of the sound source according to the above-mentioned relational expression (1), the sound pressure signal of the sound source can output the sound wave within the frequency band of f₀−fₐ˜f₀+fₐ. Referring to FIG. 2B, the acoustic environmental impedance is modulated based on the ultrasonic frequency f₀ of the sound source. Referring to FIG. 2C, the sound signal within the audible sound frequency band fₐ can be generated after modulating the sound pressure signal of the sound source with the acoustic environmental impedance based on the above-mentioned principle.

FIG. 3 is a schematic structural diagram of a first type of speaker according to one or more embodiments of the present disclosure.

Referring to FIG. 3, for the first type of speaker according to the technical solutions of the present disclosure, the speaker is modulated based on the above-mentioned principle and includes: a diaphragm structure 101 and a cover plate structure 102. The diaphragm structure 101 includes a first diaphragm 111 and a second diaphragm 121. The second diaphragm 121 is arranged around the first diaphragm 111. The first diaphragm 111 is configured to push air to vibrate so as to generate an initial sound wave B0. A signal of the initial sound wave B0 is modulated based on a signal of the audible sound frequency band. The modulation manner can refer to the above-mentioned relational expression (1).

The cover plate structure 102 and the diaphragm structure 101 enclose to form a sound-generating cavity 103. The cover plate structure 102 has a sound outlet hole 104. The sound outlet hole 104 connects the sound-generating cavity 103 with outside. The initial sound wave B0 in the sound-generating cavity 103 is transmitted to the outside through the sound outlet hole 104 to form a sound signal B1. The sound outlet hole 104 is arranged opposite to the first diaphragm 111. The cover plate structure 102 at least blocks the second diaphragm 121. In this way, the second diaphragm 121 and the cover plate structure 102 form an acoustic environmental impedance. The acoustic environmental impedance is used to modulate the initial sound wave B0 to change the sound pressure of the sound signal. The modulation manner of the acoustic environmental impedance can refer to the above-mentioned relational expression (2).

The first diaphragm 111 can be manufactured through the MEMS (micro-electro-mechanical system) manufacturing process using SOI (Silicon on Insulator/Si) or POI (Polysilicon on Insulator/Polysilicon) wafers.

The second diaphragm 121 can be manufactured through the MEMS (micro-electro-mechanical system) manufacturing process using SOI (Silicon on Insulator/Si) or POI (Polysilicon on Insulator/Polysilicon) wafers.

In one or more embodiments, the structure of the first diaphragm 111 can be the same as that of the second diaphragm 121. Alternatively, the structure of the first diaphragm 111 can be different from that of the second diaphragm 121.

A driving method of the first diaphragm 111 includes electrostatic driving, piezoelectric driving or electromagnetic driving.

A driving method of the second diaphragm 121 includes electrostatic driving, piezoelectric driving or electromagnetic driving.

In some embodiments, the driving method of the first diaphragm 111 can be the same as that of the second diaphragm 121. Alternatively, the driving method of the first diaphragm 111 can be different from that of the second diaphragm 121.

A shape of the first diaphragm 111 can be circular, square, hexagonal or annular.

A shape of the second diaphragm 121 can be circular, square, hexagonal or annular.

Referring to FIG. 3, the speaker further includes a support structure 105. The support structure 105 includes a support cylinder 125 and support pillars 115. The support cylinder 125 is cylindrical. The perimeter of the second diaphragm 121 is fixed to the inner wall of the support cylinder 125. The perimeter of the first diaphragm 111 is fixed to the second diaphragm 121 through the support pillars 115.

The cross-section of the support cylinder 125 can be configured as a wall with a shape of circular, elliptical, rectangular or rounded-corner rectangular (oblong).

In some embodiments, the support pillars 115 can form a continuous structure arranged around the first diaphragm 111. Alternatively, the number of support pillars 115 can be multiple, and the multiple support pillars 115 are arranged at intervals around the first diaphragm 111.

Optionally, the frequency of the initial sound wave B0 is a preset frequency, and the second diaphragm 121 is configured to vibrate at the preset frequency, thus achieving the modulation of the acoustic environmental impedance.

In some embodiments, a single sound outlet hole 104 or multiple sound outlet holes 104 can be arranged. A shape of the sound outlet hole 104 can be circular, elliptical, triangular, quadrilateral, hexagonal or arc-shaped.

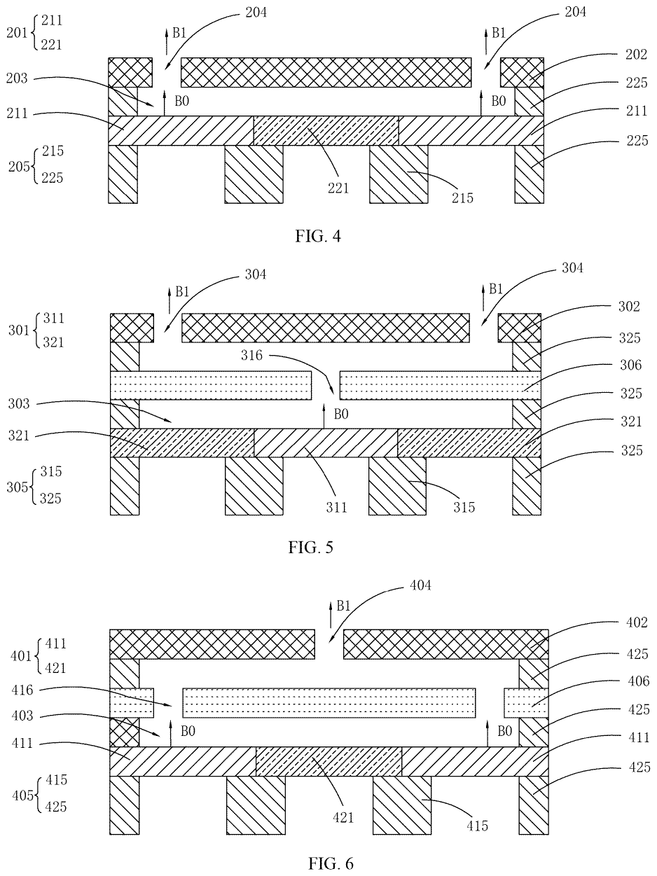

FIG. 4 is a schematic structural diagram of a second type of speaker according to one or more embodiments of the present disclosure.

Referring to FIG. 4, for the second type of speaker according to the technical solutions of the present disclosure, the speaker is modulated based on the above-mentioned principle and includes: a diaphragm structure 201 and a cover plate structure 202. The diaphragm structure 201 includes a first diaphragm 211 and a second diaphragm 221. The first diaphragm 211 is arranged around the second diaphragm 221. The first diaphragm 211 is configured to push air to vibrate so as to generate an initial sound wave B0. A signal of the initial sound wave B0 is modulated based on a signal within the audible sound frequency band. The modulation manner can refer to the above-mentioned relational expression (1).

The cover plate structure 202 and the diaphragm structure 201 enclose to form a sound-generating cavity 203. The cover plate structure 202 has sound outlet holes 204. The sound outlet holes 204 connect the sound-generating cavity 203 with outside. The initial sound wave B0 in the sound-generating cavity 203 is transmitted to the outside through the sound outlet holes 204 to form a sound signal B1. The sound outlet holes 204 are arranged opposite to the first diaphragm 211. The cover plate structure 202 at least blocks the second diaphragm 221. In this way, the second diaphragm 221 and the cover plate structure 202 form an acoustic environmental impedance. The acoustic environmental impedance is used to modulate the initial sound wave B0 to change the sound pressure of the sound signal. In some embodiments, the modulation method of the acoustic environmental impedance can refer to the above-mentioned relational expression (2).

The parts of the first diaphragm 211 and the second diaphragm 221 that are the same as or corresponding to those of the first diaphragm 111 and the second diaphragm 121 in the first embodiment can be referred to the previous embodiments. No further elaboration will be made here.

Referring to FIG. 4, the speaker further includes a support structure 205. The support structure 205 includes a support cylinder 225 and support pillars 215. The support cylinder 225 is cylindrical. The perimeter of the first diaphragm 211 is fixed to the inner wall of the support cylinder 225. The perimeter of the second diaphragm 221 is fixed to the first diaphragm 211 through the support pillars 215.

In some embodiments, the support pillars 215 can form a continuous structure arranged around the second diaphragm 221. Alternatively, the number of support pillars 215 can be multiple, and the multiple support pillars 215 are arranged at intervals around the second diaphragm 221.

In some embodiments, the shape of the sound outlet hole 204 can be set as arc-shaped, circular, elliptical, triangular, quadrilateral or hexagonal, etc. The number of sound outlet holes 204 can be set to be multiple, and the multiple sound outlet holes 204 are arranged at intervals along the circumferential direction of the second diaphragm 221.

FIG. 5 is a schematic structural diagram of a third type of speaker according to one or more embodiments of the present disclosure.

Referring to FIG. 5, for the third type of speaker according to the technical solutions of the present disclosure, the speaker is modulated based on the above-mentioned principle and includes: a diaphragm structure 301, a cover plate structure 302, and an intermediate layer 306. The diaphragm structure 301 includes a first diaphragm 311 and a second diaphragm 321. The second diaphragm 321 is arranged around the first diaphragm 311. The first diaphragm 311 is configured to push air to vibrate so as to generate an initial sound wave B0. A signal of the initial sound wave B0 is modulated based on a signal within the audible sound frequency band. The modulation manner can refer to the above-mentioned relational expression (1).

The cover plate structure 302 and the diaphragm structure 301 enclose to form a sound-generating cavity 303. The cover plate structure 302 has sound outlet holes 304. The sound outlet holes 304 connect the sound-generating cavity 303 with outside. The initial sound wave B0 in the sound-generating cavity 303 is transmitted to the outside through the sound outlet holes 304 to form a sound signal B1.

The intermediate layer 306 is disposed within the sound-generating cavity 303, located between the diaphragm structure 301 and the cover plate structure 302. The intermediate layer 306 has a through-hole 316 that penetrates thickness of the intermediate layer 306. The through-hole 316 is arranged opposite to the first diaphragm 311, and the through-hole 316 and the sound outlet holes 304 are arranged in a staggered manner. The intermediate layer 306 at least blocks the second diaphragm 321 to form an acoustic environmental impedance together with the second diaphragm 321 and the cover plate structure 302. The acoustic environmental impedance is used to modulate the initial sound wave B0 to change the sound pressure of the sound signal. In some embodiments, the modulation method of the acoustic environmental impedance can refer to the above-mentioned relational expression (2).

The acoustic environmental impedance formed by the intermediate layer 306, the second diaphragm 321, and the cover plate structure 302 includes the main acoustic environmental impedance and the matching acoustic environmental impedance. The main acoustic environmental impedance is formed based on the second diaphragm 321 and the intermediate layer 306, and the matching acoustic environmental impedance is formed based on the intermediate layer 306 and the cover plate structure 302.

In some embodiments, the intermediate layer 306 can be a stationary layer, which means it does not move or vibrate. In some other embodiments, the intermediate layer 306 can be a movable layer, that is, the intermediate layer 306 can vibrate or move to further achieve the modulation of the initial sound wave B0.

In some embodiments, the number of through-holes 316 can be one or multiple. The through-holes 316 can be shaped as arc-shaped, circular, elliptical, triangular, quadrilateral, hexagonal, etc.

The parts of the first diaphragm 311 and the second diaphragm 321 that are the same as those of the first diaphragm 111 and the second diaphragm 121 in the first embodiment or similar parts can be referred to the previous embodiments. No further elaboration will be made here.

Referring to FIG. 5, the speaker further includes a support structure 305. The support structure 305 includes a support cylinder 325 and support pillars 315. The support cylinder 325 is in a cylindrical shape. The perimeter of the first diaphragm 311 is fixed to the inner wall of the support cylinder 325, and the perimeter of the intermediate layer 306 is also fixed to the inner wall of the support cylinder 325. The perimeter of the first diaphragm 311 and the second diaphragm 321 are fixed together through the support pillars 315.

In some embodiments, the support pillars 315 can be arranged as a continuous structure around the first diaphragm 311. Alternatively, the number of support pillars 315 can be multiple, and the multiple support pillars 315 are arranged at intervals around the first diaphragm 311.

In some embodiments, the sound outlet hole 304 can be configured in shapes such as arc-shaped, circular, elliptical, triangular, quadrilateral or hexagonal. Multiple sound outlet holes 304 can provided, and the multiple sound outlet holes 304 are arranged at intervals along the circumferential direction of the first diaphragm 311.

FIG. 6 is a schematic structural diagram of a fourth type of speaker according to one or more embodiments of the present disclosure.

Referring to FIG. 6, for the fourth type of speaker according to the technical solutions of the present disclosure, the speaker is modulated based on the above-mentioned principle and includes: a diaphragm structure 401, a cover plate structure 402, and an intermediate layer 406. The diaphragm structure 401 includes a first diaphragm 411 and a second diaphragm 421. The first diaphragm 411 is arranged around the second diaphragm 421. The first diaphragm 411 is configured to push air to vibrate so as to generate an initial sound wave B0. A signal of the initial sound wave B0 is modulated based on a signal within the audible sound frequency band. The modulation manner can refer to the above-mentioned relational expression (1).

The cover plate structure 402 and the diaphragm structure 401 enclose to form a sound-generating cavity 403. The cover plate structure 402 has a sound outlet hole 404. The sound outlet hole 404 connects the sound-generating cavity 403 with outside. The initial sound wave B0 in the sound-generating cavity 403 is transmitted to the outside through the sound outlet hole 404 to form a sound signal B1.

The intermediate layer 406 is disposed within the sound-generating cavity 403, and located between the diaphragm structure 401 and the cover plate structure 402. The intermediate layer 406 has through-holes 416 that penetrate thickness of the intermediate layer 406. The through-holes 416 are arranged opposite to the first diaphragm 411, and the through-holes 416 and the sound outlet hole 404 are arranged in a staggered manner. The intermediate layer 406 at least blocks the second diaphragm 421 to form an acoustic environmental impedance together with the second diaphragm 421 and the cover plate structure 402. The acoustic environmental impedance is used to modulate the initial sound wave B0 to change the sound pressure of the sound signal. In some embodiments, the modulation method of the acoustic environmental impedance can refer to the above-mentioned relational expression (2).

The acoustic environmental impedance formed by the intermediate layer 406, the second diaphragm 421, and the cover plate structure 402 includes the main acoustic environmental impedance and the matching acoustic environmental impedance. The main acoustic environmental impedance is formed based on the second diaphragm 421 and the intermediate layer 406, while the matching acoustic environmental impedance is formed based on the intermediate layer 406 and the cover plate structure 402.

In some embodiments, the intermediate layer 406 can be a stationary layer, namely it does not move or vibrate. In some other embodiments, the intermediate layer 406 can be a movable layer, that is, the intermediate layer 406 can vibrate or move to further achieve the modulation of the initial sound wave B0.

In some embodiments, the through-hole 416 can be set in shapes such as arc-shaped, circular, elliptical, triangular, quadrilateral or hexagonal. The number of through-holes 416 can be multiple, and the multiple through-holes 416 are arranged at intervals along the circumferential direction of the second diaphragm 421.

The parts of the first diaphragm 411 and the second diaphragm 421 that are the same as those of the first diaphragm 111 and the second diaphragm 121 in the first embodiment or similar parts can be referred to the previous embodiments. No further elaboration will be made here.

Referring to FIG. 6, the speaker further includes a support structure 405. The support structure 405 includes a support cylinder 425 and support pillars 415. The support cylinder 425 is cylindrical. The perimeter of the second diaphragm 421 is fixed to the inner wall of the support cylinder 425, and the perimeter of the intermediate layer 406 is also fixed to the inner wall of the support cylinder 425. The perimeter of the first diaphragm 411 and the second diaphragm 421 are fixed through the support pillars 415.

In some embodiments, the support pillars 415 can be a continuous structure arranged around the second diaphragm 421. Alternatively, multiple support pillars 415 can be provided, and the multiple support pillars 415 are arranged at intervals around the second diaphragm 421.

In some embodiments, the sound outlet hole 404 can be set to one or multiple. The shape of the sound outlet hole 404 can be circular, elliptical, triangular, quadrilateral, hexagonal, or arc-shaped.

In any of the speakers in the above first to fourth embodiments, it may further include: a shielding element (not shown in the drawings). The shielding element is located on a side of the cover plate structure away from the sound-generating cavity, and the shielding element at least blocks part of the sound outlet hole. In this way, the shielding element can form an acoustic path impedance. The initial sound wave is jointly modulated based on the acoustic environmental impedance and the acoustic path impedance in the above embodiments, so that the speaker outputs a sound signal including the audible sound frequency band.

In some embodiments, the shielding element can vibrate along the sound-generating direction of the sound outlet hole to modulate the output sound signal. Alternatively, the shielding element can translate back and forth in a direction parallel to the cover plate structure to block or open the sound outlet hole, thereby achieving modulation of the output sound signal.

In some embodiments, the shape of the shielding element can be designed according to the shape of the sound outlet hole.

For the speaker according to the technical solutions of the present disclosure, a sound-generating cavity is formed by the enclosure of the diaphragm structure and the cover plate structure. The diaphragm structure includes a first diaphragm and a second diaphragm. The first diaphragm is configured to push air to vibrate and generate an initial sound wave. The second diaphragm and the cover plate structure form an acoustic environmental impedance, which is used to modulate the initial sound wave, so that the sound signal transmitted from the sound outlet hole on the cover plate structure is within the audible sound frequency band.

Correspondingly, embodiments of the present disclosure further provide an electronic device, which includes the speaker as described in the above embodiments, so as to modulate and output a sound signal covering the audible sound frequency band based on the acoustic environmental impedance.

In some embodiments, the electronic devices may include the devices with speakers such as mobile phones, tablet computers, laptop computers, personal digital assistants (PDA), cameras, personal computers, in-vehicle devices, wearable devices, augmented reality (AR) glasses, AR helmets, virtual reality (VR) glasses, VR helmets, landline handsets (pickup), medical assistive devices (such as hearing aid), and various types of headphones (such as wireless or wired headphones). The embodiments of the present disclosure do not impose any special restrictions on the specific forms of the above-mentioned electronic devices.

Those of ordinary skill in the art can understand that the above-mentioned various embodiments are specific implementation methods of the present disclosure. In practical applications, various changes can be made to them in form and details without departing from the spirit and scope of the present disclosure.

What is claimed is:

1. A speaker, comprising:
a diaphragm structure comprising a first diaphragm and a second diaphragm, wherein the first diaphragm is configured to push air to vibrate so as to generate an initial sound wave, and a signal of the initial sound wave is modulated based on a signal within an audible sound frequency band; and
a cover plate structure, wherein the cover plate structure and the diaphragm structure enclose to form a sound-generating cavity, the cover plate structure has at least one sound outlet hole, and the at least one sound outlet hole connects the sound-generating cavity with outside, the initial sound wave in the sound-generating cavity is transmitted through the at least one sound outlet hole to the outside so as to form a sound signal, the second diaphragm and the cover plate structure jointly generate an acoustic environmental impedance, and the acoustic environmental impedance is configured to modulate the initial sound wave to change sound pressure of the sound signal.

2. The speaker as described in claim 1, wherein a frequency of the initial sound wave is a preset frequency, and the second diaphragm is configured to vibrate at the preset frequency.

3. The speaker as described in claim 1, wherein the first diaphragm is arranged around the second diaphragm.

4. The speaker as described in claim 1, wherein the second diaphragm is arranged around the first diaphragm.

5. The speaker as described in claim 1, wherein the at least one sound outlet hole is arranged directly opposite to the first diaphragm, and the cover plate structure at least blocks the second diaphragm.

6. The speaker as described in claim 1, wherein an intermediate layer is provided within the sound-generating cavity, the intermediate layer is located between the diaphragm structure and the cover plate structure, the intermediate layer has at least one through-hole penetrating through the intermediate layer, the at least one through-hole is arranged directly opposite to the first diaphragm, and the at least one through-hole and the at least one sound outlet hole are arranged in a staggered manner; and the intermediate layer at least blocks the second diaphragm to form the acoustic environmental impedance together with the second diaphragm and the cover plate structure.

7. The speaker as described in claim 1, wherein a driving mode of the first diaphragm comprises electrostatic driving, piezoelectric driving or electromagnetic driving, and a driving mode of the second diaphragm comprises electrostatic driving, piezoelectric driving or electromagnetic driving.

8. The speaker as described in claim 1, wherein a shape of the first diaphragm comprises circular, square, hexagonal or annular, and a shape of the second diaphragm comprises circular, square, hexagonal or annular.

9. The speaker as described in claim 1, further comprising:
a shielding element located on a side of the cover plate structure away from the sound-generating cavity, wherein the shielding element at least blocks part of the at least one sound outlet hole.

10. An electronic device, comprising the speaker as described in claim 1.
